(19) United States
(12) Patent Application Publication
(10) Pub. No.: US 2009/0067600 A1
(43) Pub. Date: Mar. 12, 2009

(54) Method And Arrangement For Services Running On Service Execution Platform

(76) Inventor: Knut Eilif Husa, Sande i Vestfold (NO)

Correspondence Address: ERICSSON INC., 6300 LEGACY DRIVE, M/S EVR 1-C-11, PLANO, TX, 75024, US

(21) Appl. No.: 11/574,104

(22) PCT Filed: Mar. 22, 2005
(86) PCT No.: PCT/NO2005/000103

§ 371 Date: Feb. 22, 2007

(51) Int. Cl. H04M 3/42

(52) U.S. Cl. 379/201.12

(57) ABSTRACT

The present invention discloses an arrangement for providing high availability and high robustness for services running on service execution platforms, comprising service components categorized according to different service types, such as weather and/or position. Where the arrangement further comprises: a one or more handheld communication device, a service platform and a one or more 3rd party service providers. Further it is disclosed a method implementing the arrangement by the step of categorizing external service components according to their service types, where the method further comprises at least one of the following steps: registration of all the external service components into a list of objects representative of their type of service, and sending from a service platform a heartbeat function for checking and registration of the current status of the service components.

### FIELD OF THE INVENTION

The present invention discloses a method and an arrangement which provides high availability and robustness to services running on service execution platform, and uses external sources to fulfil the information need for the service (e.g. weather forecast delivered by MMS).

### BACKGROUND OF THE INVENTION

Today it is common that end users subscribes to services for use/deliverance to their handheld devices such as their mobile phone or their PDA. These services may typically be positioning services, weather services or any other information service. In the following the wording VAS, value added service, will be used for these kind of services delivered to handheld devices.

Today a typical VAS service uses service components external to its own service execution environment. The VAS service then typically, subscribes for information provided by the external service. If one of these external service components is malfunctioning, it puts the overall service out of order. For this invention to be applicable we assume that there exist several external service components that can provide the requested information. Typical examples of such services will be weather forecast, share prices, map data, route planning, etc.

An example is a weather forecast service that gives the user the weather report at the user's current location. This service forwards the mobile subscribers position to the weather forecast service, which returns the weather forecast in the requested area. If the weather service is out of order, the overall service cannot fulfil its execution.

The problem today is that there is no mechanism that ensures availability of VAS services independent of external service components. Although some of the problems are addressed in the below referenced patent publication it does not ensure a satisfactory combination of robustness, availability and implementation simplicity.

WO 20004925 describes a solution that chooses distribution channels based on a comparison of identifiers with reference values. However it does not describe any kind of well functioning pinging between a numbers of third part service providers such as positioning providers hence there is no mechanism ensuring that the needed components are fulfilling the needed quality of service.

Further it is known that BEA Weblogic one of the main providers of application servers on the market has a product BEA Weblogic Integration in their product portfolio specifically targeting business integration. By use of controls it is possible to access remote service components exposed as a Web service.

Thus from the discussion above it should be obvious that there is a need for a method that provides high availability and robustness to services running on service execution platform, and uses external sources to fulfil the information need for the service.

### SUMMARY OF THE INVENTION

The features as defined by the independent claim enclosed characterize this arrangement and method.

In particular it is disclosed a method for providing high availability and high robustness for services running on service execution platforms, specified in the step of categorizing external service components according to their service types, such as weather and/or position services, where the method further comprises at least one of the following steps: registration of all the external service components into a list of objects representative of their type of service, and sending from a service platform a heartbeat function for checking and registration of the current status of the service components.

Further it is disclosed a communication arrangement adapted to provide high availability and high robustness for services running on service execution platforms, comprising service components categorized according to different service types, such as weather and/or position, specified in that the arrangement further comprises:
a) a one or more handheld communication device adapted to communicate with a service platform,
b) a service platform including VAS services and a VAS robustifying mechanism adapted to communicate with the one or more handheld communication device and to communicate with one or more 3^{rd} party service providers, and
c) a one or more 3^{rd} party service providers adapted to communicate with the service platform.

### BRIEF DESCRIPTION OF THE DRAWINGS

In order to make the invention more readily understandable, the discussion that follows will refer to the accompanying drawing.

FIG. 1 shows the domains of the invention,

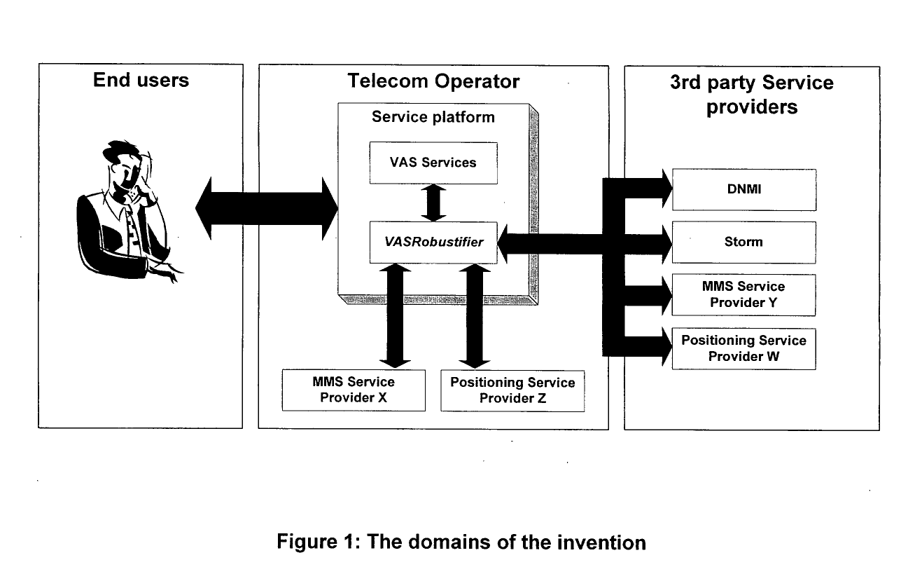

FIG. 2 shows Operator network,

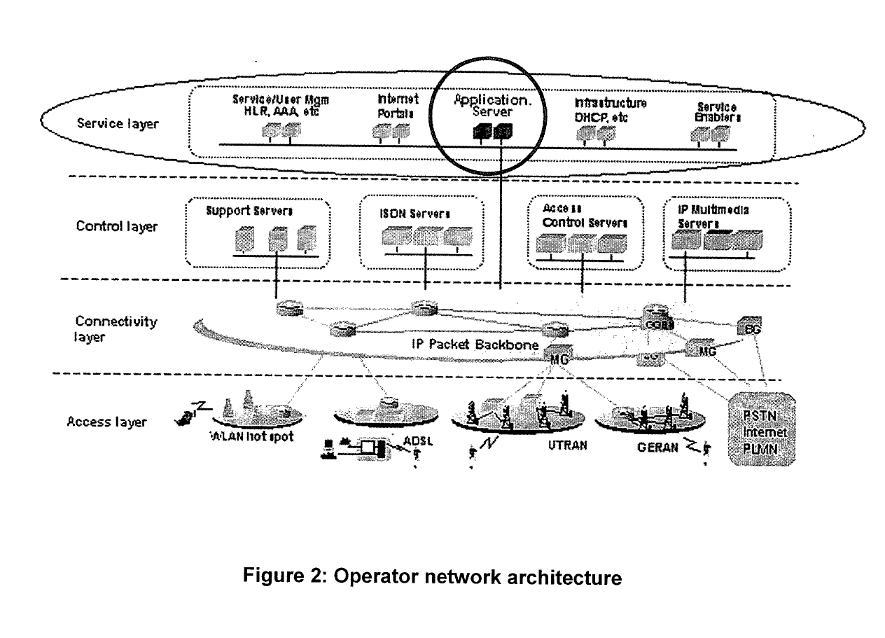

FIG. 3: Getting status of service components and usage,

FIG. 4: Procedure of Service Component subscription,

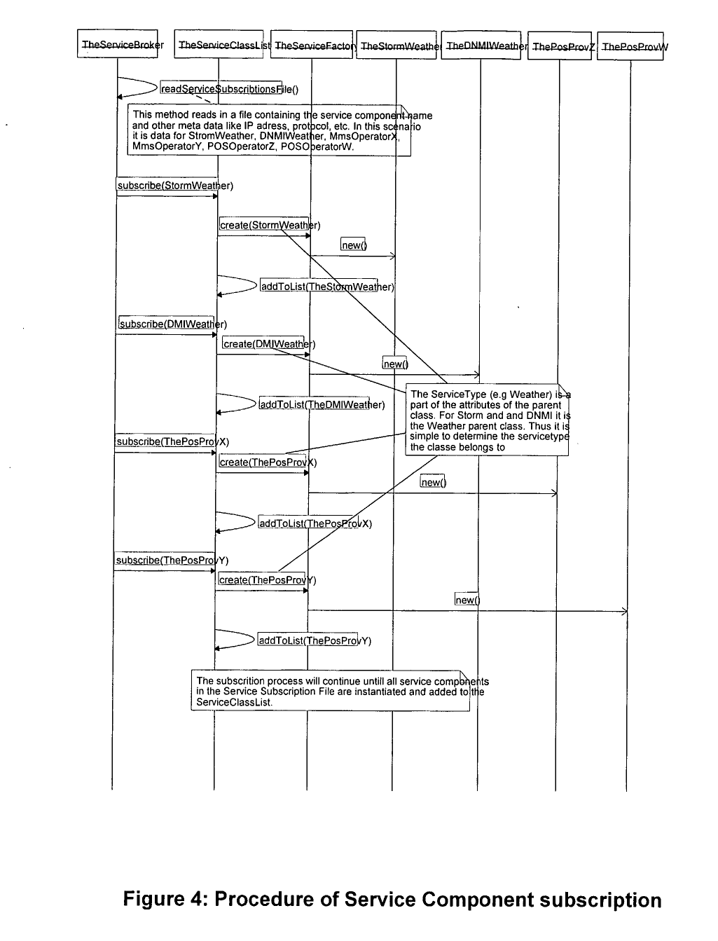

FIG. 5: Class diagram of the VASRobustifier,

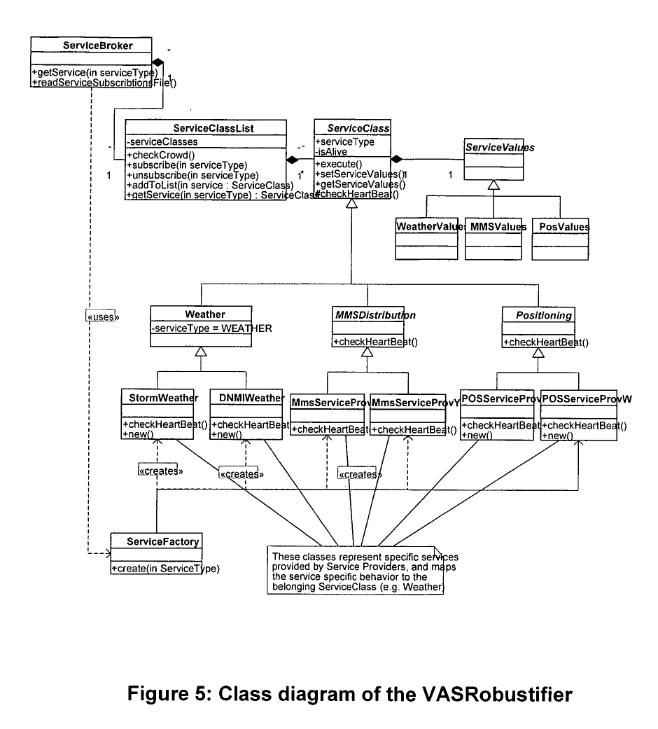

FIG. 6: Deployment diagram of the Service.

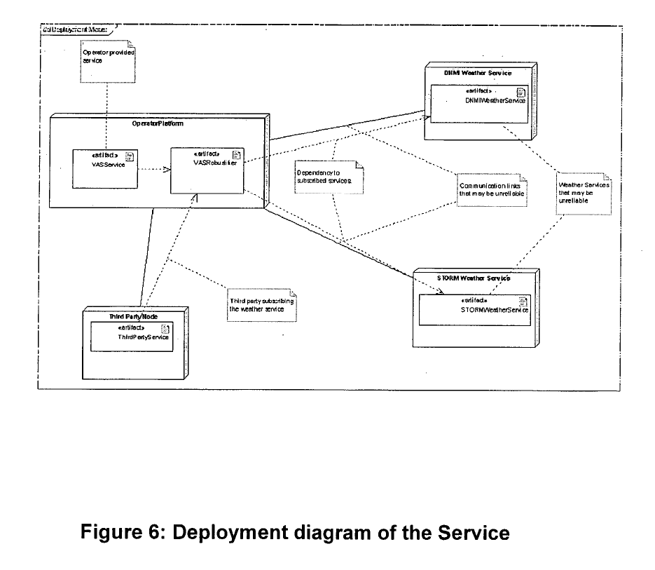

### DETAILED DESCRIPTION OF THE INVENTION

In the following the present invention will be discussed by describing a preferred embodiment, and by referring to the accompanied drawings.

Today's VAS solutions often use service components outside its own execution domain. Thus the service chain is jeopardized if invoked service components are unreliable. The present invention solidifies the entire service environment by registering all available external components and generalising them into “service classes”. Hence, e.g. all positioning providers or all weather-report providers are put under the Class Position and Weather respectively. Heart-beat and status checks in combination with a certain degree of service redundancy ensure that the best-available service component under each class is invoked, leading to optimal service chain reliability and, in the end, to a higher QoS for the end user.

The core of the present invention is in an intelligent way to combine many providers of one and the same type of service, with service health-checks i.e. what is the present status of these services.

Among its main technical features is its mechanism that robustifies VAS services independently of unreliable service components.
The invention will robustify and increase QoS of VAS services dependant of external service components.
The invention hides the complexity of ensuring robust service quality for the overall service.
The invention provides a uniform way of providing high availability and robustness for heterogeneous service components.
The present invention provides high availability to services that normally uses unreliable service components.

The invention is implemented as a software update of the service execution environment.

### A FIRST PREFERRED EMBODIMENT OF THE INVENTION

In the following a first preferred embodiment of the invention will be described, with reference to the accompanied drawings.

As indicated in the previous section the solution to the problems created by the unstable service providers were to firstly, take advantage of the redundancy among the services provided by service providers, secondly to implement a mechanism that in an efficient way is polling or pinging each and every of the service providers for their health.

A more detailed description of the control/health check mechanism will be given in the following as will the principle of redundancy by way of example.

All external service components will be registered in this mechanism, and generalised into an abstracted service class. E.g. imagine the weather forecast companies “First Weather Service” and the “Second Weather Service” both will be members of the service class WEATHER. The mechanism will also contain a heartbeat function that checks whether the service components (e.g. First Weather Service) are alive. The current status of the service components will be registered.

The overall services will consist of service classes such as WEATHER, POSITIONING and many more, and it will not take into consideration which actual components are accessed. The overall service will get a reference to a functioning service component fulfilling the functional requirements from the overall service. If, for example, First Weather service is out of order, the overall service will get a reference to another registered component in the requested WEATHER service class (e.g. SECOND weather service).

shows the different domains involved in the context of the invention (end users, telecom operator, and 3^{rd} party service providers), and where a VASRobustifier (a service broker) resides. The end user will typically access a service in the telecom operator's service platform, and the service platform will use the VASRobustifier to ensure that the VAS services use well-working service components provided by either internal or external service providers.

Feil! Fant ikke referansekilden. shows the architecture of an operator network. The VASRobustifier will in such a picture typically reside in the Application Server nodes (typically based on J2EE or .NET technology) indicated by the circle on the service layer.

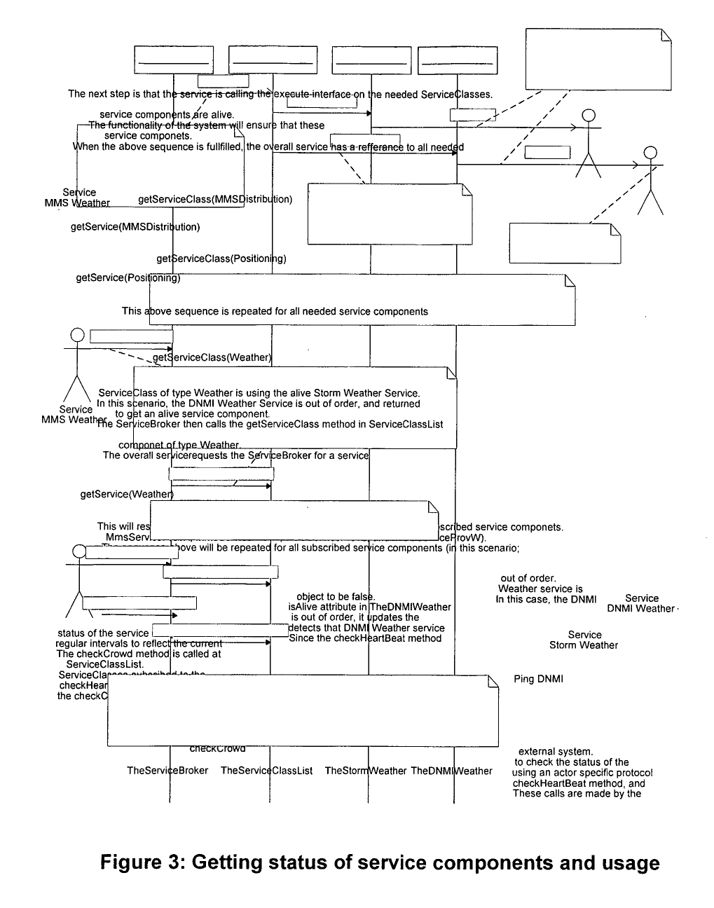

FIG. 3 describes the process of getting the status of all subscribed service components, and an example of usage. The process starts with a request for a health check from the ServiceBroker to the class containing a list of service components (the ServiceClassList). One simple way of performing the health check is to ping each subscribed component. This might however, not be sufficient as the service can reside behind firewalls not allowing the ping protocol. Further, a positive response on a ping request does not ensure a working service; it only gives an indication that the node that is running the service is reachable. For even better control of the service status, it is feasible to actually request the service through the service interface. The ServiceClassList will then request each subscribed service components to perform a health check of the component. The statuses of the service components are stored in the ServiceClassList. In the example is the SECOND Weather service out of order.

The other process described in Figure is usage of the VASRobustifier to retrieve well-working service components. The ServiceBroker gets a request from a VAS service for a service component of type Weather. This request is forwarded to the ServiceClassList, which will return a reference to a working weather service component (in this scenario; First Weather Service). The same process is repeated for MMS and location.

The invention has thus, removed the subscribed services as a single point of failure. The VASRobustifier runs in an operator-controlled environment, and the probability that it fails will be much lower than the probability that one of the subscribed services fails. Hence, we have gained a better availability of the over-all service.

The mechanism can also be extended to support prioritisation of equal service components based on different parameters. E.g. one service component has historically better Quality of Services, is cheaper, more reliable data, etc. The health check process described above can be used to gather statistical data serving as a basis for the prioritisation task. The two boxes of the following figure shows an example where weather services are assigned priorities for instance based on response times.

| | |
|---|---|
| The second | The first |
| weather service | weather service |
| Priority = 1 | Priority = 2 |

Figure: Example of priorities assigned to weather services

### Subscription of Service Components

Figure below describes the subscription procedure for the service components to the VASRobustifier.

All relevant data of the service components offered by the VASRobustifier mechanism are read in to the system at start-up. The ServiceClassList component will then use this information to create an instance of all ServiceClasses interfacing different service components.

The procedure will create an instance, a ServiceClass for each subscribed service component.

Distributed services may represent similar information in different ways. An example is that the SECOND Weather Service returns temperatures in Celsius degrees while the First Weather Service uses Fahrenheit degrees to indicate the same property. The ServiceClass responsibility is to map the set of properties of the subscribed service, e.g. the First Weather Service, to the set of VASRobustifier Weather properties.

### Class Diagram

Figure below shows a model of the main classes of the VASRobustifier and the relation between them. The use of abstraction, inheritance and association is the main driver of the realization of the VASRobustifier.

### Deployment Diagram

Figure shows a deployment diagram of the VASRobustifier. It will typically reside in an operator controlled domain and subscribe services that are in domains where the operator has no control. Although the invention does not specifically mention any access technology, the VASRobustifier will typically use Web Services both as a means of interacting with the subscribed service components and exposing its own interface. Further, the VASRobustifer may be implemented as a server component using component integration technologies such as Java Connector Architecture (JCA). This will make it easy to integrate the VASRobustifer into existing service platforms, as most of them are based on standardized technology such as J2EE.

### Advantages

The mechanism described above will robustify and increase QoS of VAS services dependant of external service components.

The invention hides the complexity of ensuring robust service quality for the overall service.

The invention provides a uniform way of providing high availability and robustness for heterogeneous service components.

The invention will provide high availability to services that normally uses unreliable service components.

In the previous sections the present invention has been described by way of examples, particularly an example using a health check mechanism as known from Java has been shown, however it is obvious that any mechanism that performs a polling process where the polling/pinging is sent from a sender to a number of services categorised into groups or classes according to their services, where the polling is effectuated between redundant services within separated classes or groups is possible. The use of checkCrowd and checkHeartBeat and the actor specific protocol is merely meant for making the present invention more readily understandable.

### ABBREVIATION

### MMS Multimedia Messaging

### POS Positioning System

VAS Value Added Services

1-19. (canceled)

20. A method for providing high availability and high robustness for services running on service execution platforms,
characterized in the step of categorizing external service components according to their service types, such as weather and/or position services, where the method further comprises at least one of the following steps:
a) registration of all the external service components into a list of objects representative of their type of service, and
b) sending from a service platform a heartbeat function for checking and registration of the current status of the service components.

21. The method according to claim 20,
characterized in that the method further comprises the step of prioritization among service components categorized in the same type of service.

22. The method according to claim 21,
characterized in the step of categorizing the service components into at least one of the following service types:
a) weather forecast,
b) share prices,
c) map data, or
d) route planning.

23. The method according to claim 20,
characterized in that the mechanism adapted to robustify a VAS services sends one or more health check requests to at least a substantial fraction of the service components, where the sending comprises the steps of:
a) pinging each component to check if the services running on an available node, i.e. an incomplete health check,
b) requesting the service through the service interface, i.e. a complete health check, and/or
c) the status of each service component is derived from the health check response and stored in the object representing the service component.

24. The method according to claim 23,
characterized in that using the response from the health check request process as a basis for prioritization among service components of the same service type.

25. The method according to claim 24,
characterized in deriving status of service components of the same service type from different parameters such as
a) Quality of Service,
b) cost,
c) reliable data or information, or
d) response time.

26. The method according to claim 20,
characterized in that at creation of an object representing the service component insert this object into a list of objects representing the service components.

27. The method according to claim 26,
characterized in the step of mapping all properties from the service component to a common set of properties, defined centrally by a mechanism adapted to robustify VAS services and the object representing the service component contains the mapping.

28. The method according to claim 20,
characterized in that the method comprises the step of establishing external services said services running outside the service execution platform.

29. The method according to claim 28,
characterized in that the method comprises the step of:
establishing services provided from third parties outside a service provider domain, or
establishing services running inside the service provider domain.

30. The method according to claim 20,
characterized in that the method establishes VAS services as high level services dependent on low level service types to provide its own service.

31. The method according to claim 30,
characterized in that the method establishes a VAS service where the VAS service provides weather information for a user location dependent on the low level services types; mobile location and weather information.

32. The method according to any of the claim 20,
characterized in that the method for providing high availability and robustness of a VAS services includes the step of:
a) VAS services requests information from a 3^{rd} party service components, and the 3^{rd} party service components responds, and
b) the VAS services running on a service execution platform contains a robustifier mechanism, and
c) the 3^{rd} party VAS services requests robustified services components from the robustifier mechanism, and
d) a end users requests the VAS services.

33. The method according to claim 32,
characterized in that the robustifier mechanism uses a Web Services as a means of interacting with the service components.

34. A communication arrangement adapted to provide high availability and high robustness for services running on service execution platforms, comprising service components categorized according to different service types, such as weather and/or position
characterized in that the arrangement further comprises:
a) a one or more handheld communication device adapted to communicate with a service platform,
b) a service platform including VAS services and a VAS robustifying mechanism (FIG. 15) adapted to communicate with the one or more handheld communication device and to communicate with one or more 3^{rd} party service providers, and
c) a one or more 3^{rd} party service providers adapted to communicate with the service platform.

35. The communication arrangement according to claim 34,
characterized in that the 3^{rd} party service provider environment contains application server node(s) adapted to use software component integration technologies like Java Connector Architecture (JCA), and software platforms based on J2EE or .Net technology.

36. The communication arrangement according to claim 34,
characterized in that a object, where the object is derived from registration of external service components into a list of objects, representing a service component containing a mapping of all properties from the service component to a common set of properties, defined centrally by the VAS robustifier mechanism.

37. The arrangement according to claim 34,
characterized in that the service execution platform resides in the 3^{rd} party service provider environment, such as telecom operator network and/or internet service provider network.

38. The method according to claim 20,
characterized in that the method comprises the step of establishing external services that are services running outside the service execution platform.
